(19) United States
(12) Patent Application Publication
(10) Pub. No.: US 2013/0118047 A1
(43) Pub. Date: May 16, 2013

(54) METHOD FOR PRODUCING A TRANSPARENT OBJECT ATTRACTING A VIEWER'S ATTENTION, AND A CORRESPONDING OBJECT

(71) Applicant: Frank Buddenhagen GmbH, Hamburg (DE)

(72) Inventors: Frank BUDDENHAGEN, Hamburg (DE); Lutz STÖHR, Hamburg (DE); Peter SPIESS, Hamburg (DE)

(73) Assignee: Frank Buddenhagen GmbH, Hamburg (DE)

(21) Appl. No.: 13/731,772

(22) Filed: Dec. 31, 2012

Related U.S. Application Data
(63) Continuation of application No. 12/601,603, filed on Dec. 14, 2010.

(30) Foreign Application Priority Data
May 24, 2007 (DE) 10 2007 024 521.3
Oct. 29, 2007 (DE) 10 2007 051 910.0

(51) Int. Cl. F21V 7/00; G09F 13/18

(52) U.S. Cl. CPC F21V 7/00; G09F 13/18
USPC 40/581; 362/235

(57) ABSTRACT

A method for producing a transparent object that attracts a viewer's attention. At least some of the object surface facing the viewer is illuminated by means of an illumination source that irradiates a bottom surface of the object, said bottom surface facing away from the viewer. The disclosed method is characterized in that the object is provided with a surface that is reflective in incident light.

### CROSS-REFERENCES TO RELATED APPLICATIONS

This is a continuation application of U.S. patent application Ser. No. 12/601,603, filed Dec. 14, 2010, which is the U.S. National Stage of International Application No. PCT/EP2007/061060, filed Oct. 17, 2007, which designated the United States and has been published as International Publication No. WO 2008/049764 and which claims the priority of German Patent Applications, Serial No. 10 2007 024 521.3, filed May 24, 2007 and Serial No. 10 2007 051 910.0, filed Oct. 29, 2007, pursuant to 35 U.S.C. 119(a)-(d).

### BACKGROUND OF THE INVENTION

The invention relates to a method for producing a transparent object attracting a viewer's attention, wherein a surface facing the viewer is at least partially illuminated by an illumination source which illuminates a bottom surface of the object facing away from the viewer.

In addition, the invention relates to an object made of a transparent material with a bottom surface facing away from the viewer, which can be illuminated with an illumination source having light beams that pass through the material and are visible on a surface facing the viewer.

The invention also relates to a logo for identifying an object, which can be attached to the object to indicate its origin with a characteristic arrangement of lines.

Transparent objects are known, which have the surface displaying the name, the residence and optionally other information of a company or a resident residing at the address identified by the object. Such objects are frequently made as transparent plastic boxes which can be illuminated with an illumination source. This illumination source is installed inside the box and radiates towards the surface provided with the message. The illumination unit is switched on at dusk, so that the information displayed on the surface can also be read in the dark by viewers viewing the illuminated box. To this end, the identifying features applied to the surface of the box are either not transparent at all or its transparency is different from that of the box, so that the identifying features can be recognized by the viewer.

However, such boxes are not designed to be readily visible under incident light, i.e., daylight. Instead, a person interested in the address applied to the surface must search for the information when walking past the box. For example, the information recorded on the surface may have been bleached from the longtime illumination, so that this information typically does not attract the attention of a passerby, but has to be deliberately searched for. Only a limited advertising effect which draws attention can be attained with boxes labeled in this manner, so that these boxes remain mostly unnoticed.

### SUMMARY OF THE INVENTION

It is therefore an object of the invention to construct the object in such a way that it attracts the same attention under incident light, for example daylight, as when the illumination source is switched on.

The object is attained with respect to the method in that the object is provided with a surface that reflects under incident light. Due to the reflection, the correspondingly constructed surface attracts the attention also of passerby's who are in a hurry. The attractiveness of the identified surface is significantly increased by the reflection from the surface and the different signal effect of surface areas that reflect to a different degree.

With respect to the object, the same effect is attained in that the surface reflects under incident light. This reflection significantly enhances the visibility of the surface, thereby drawing attention.

Also known for identifying an object is a logo, which can be attached to the object and indicates its origin by a characteristic arrangement of lines.

Although the logo can frequently be recognized by potential buyers and is viewed as a indication for the particular quality of the goods, it can typically not be recognized in the dark, thereby losing its value as an identification cue.

With respect to the logo, it is the object of the invention to make the logo visible also in the dark, so that it can be used for identification.

This object is attained with the invention in that the lines are made of a transparent material, which is illuminated with at least one light source reproducing the lines, and that the lines are provided with coloration on at least one section of the surface facing away from the object which is transparent when the light source is switched on. The logo designed in this manner still have, as is the case with conventional logos, an externally visible coloration, for example with a metallic gloss. When it is dark, the light source is switched on, allowing the logo to be visible also in the dark.

According to a preferred embodiment of the method of the invention, the object is illuminated by the illumination source along characteristic lines commensurate with its contour. In this way, the contour of the object can also be recognized in the dark and be used for the typical applications. Likewise, characteristic surfaces of the object commensurate with its contour may be illuminated by the illumination source. The object can then also be used in the dark commensurate with its intended application.

According to another preferred embodiment of the invention, at least characteristic portions of the overall shape the object can be illuminated by the illumination source commensurate with its contour. In these cases, the remaining design of the object can be inferred from the illuminated portions of the object, allowing the object to be extensively used.

Other embodiments of the object are also suitable to use the object in the dark. For example, the surface can be provided with raised portions that diffract the illuminating light. The overall shape of the object can thereby be recognized, and the object can used.

According to another preferred embodiment of the invention, the surface can be made of a reflecting material producing a reflector effect that changes under incident light depending on the irradiation. In this way, for example, sequential operations can be performed with the object commensurate with the changing light conditions.

According to another preferred embodiment of the invention, the bottom surface can also be illuminated by the illumination source with controllable light effects. Sequential operations can be performed with the object by a suitable selection of the control.

Similar effects can also be attained by illuminating the bottom surface with a differently colored illumination source. This can also provide important information for using the object. Illumination with an intermittent illumination source is used in the similar manner. The number of pulses of the intermittent illumination source may include information important for using the object.

According to another preferred embodiment of the invention, the surface is at least partially covered with a coating, which is at least partially transparent for the light from the illumination source. In this way, certain areas of the object may be more or less intensely illuminated to thereby provide information for using object.

In a similar manner, and object can be used where individual areas of the surface have different coloration under incident light. The differently colored areas can also be provided with informational symbols which are, for example, designed as direction signs or which include prohibiting information.

According to another preferred embodiment of the invention, the surface facing the viewer may have different reflectivity. For example, individual areas of the surface may be constructed to be non-reflecting, whereas the reflection of other areas is configured differently, for example through reflection in different colors. This produces not only particularly attractive effects when using the correspondingly constructed object, but the object can also have directional features and other functions.

Preferred embodiments of the invention also relate to the object. For example, the object may have walls of different thicknesses and different reflection properties for the incident light corresponding to the respective wall thickness, as well as a different transparency of the light from the illumination source incident on the bottom surface. Depending on the intended use, the wall thickness of the object can then be selected so that information is produced with the differently reflected and differently transmitted light that is important for handling the object. In particular, according to another preferred embodiment of the invention, different reflection and transmission effects can be attained in the area of the different wall thicknesses of the object. In particular, the wall thicknesses of the object can be selected commensurate with the desired light transmission from the surface.

Areas of different coloring can be attained by producing partial layers with different thicknesses. The partial layers with different thicknesses produce different transparency effects, depending on the coloration of the material.

According to another preferred embodiment of the invention, partial layers can also be produced from a supporting foil that is provided with a colored coating. This supporting foil has a different coloration effects.

According to a preferred embodiment of the invention, a transparent plastic foil with a corresponding coloration is provided for coloring the surface. By using the transparent plastic foil, the light of the light source located inside is transmitted to the outside, so that the logo can also be recognized in the dark.

According to another preferred embodiment of the invention, the plastic foil has a surface with a transparent coating that is colored according to the desired coloration. This coating advantageously allows transmission of the light from the internal light source to the outside, and also enables the logo to appear under incident light with the desired coloration, for example with a silvery color.

According to another preferred embodiment of the invention, the coating is disposed on a side of the plastic foil facing away from the object. In this way, the object attains the bright coloration of the coating, without disturbing this effect with a coated supporting foil.

According to another preferred embodiment of the invention, the plastic foil is firmly connected with the surface of the material. This firm connection prevents detachment of the plastic foil from the material.

According to another preferred embodiment of the invention, the plastic foil is glued to the surface. The development of the adhesive technology allows the plastic foil to be glued to the surface without interfering with the transparency effect of the plastic foil.

According to another preferred embodiment of the invention, the plastic foil reflects light incident from the outside with a silvery color. This approach maintains the conventional appearance of a metallic material produced by logos that are applied on a surface.

According to another preferred embodiment of the invention, the plastic foil is implemented as a chromium foil that reflects the light incident from the outside with a silvery color. This chromium foil is commercially available at low cost and can be readily joined with the surface to be colored.

According to another preferred embodiment of the invention, the plastic foil is implemented as a foil on which gold is evaporated and which reflects the light incident from the outside with a golden color. Coloration agents reflecting with a gold color can be employed, which can be applied on a chromium foil without technical difficulties.

According to a preferred embodiment of the invention, the object is implemented as an automobile, with the backside of the material facing away from the colored surface being attached to the varnished surface. Any joining technique used to date for applying a logo on a varnished surface can be used for attaching the material with the reflecting surface. Mounting the light source inside the logo also does not pose technical difficulties or excessive costs which would prevent use of the logo.

According to another preferred embodiment of the invention, at least one layer can be electrolytically applied to the material. The thickness of this electrolytically applied layer can advantageously be precisely specified and limited to a predefined dimension. In addition, a very smooth surface without identifiable grain boundaries is produced.

According to another preferred embodiment of the invention, the transparent material is electrolytically coated with aluminum on the surface facing away from the object. This produces a thin high-gloss aluminum layer on the transparent material under incident light.

According to another preferred embodiment of the invention, the surface of the transparent material facing away from the object is electrolytically coated with chromium. Chromium firmly adheres to the transparent material and is applied so thin that light can pass through the coated material.

According to another preferred embodiment of the invention, a first electrolytic bath for coating the transparent material with copper and a second electrolytic bath for coating the copper deposited on the material with chromium are provided. This produces a very durable and uniform metal coating which develops a high gloss under incident light. With the electrolytic process, these layers can be maintained so thin that they are easily recognizable in transmitted light, without losing their gloss under incident light.

According to another preferred embodiment of the invention, the transparent material has a cover layer facing away from the object with a thickness of at most 10 μm. The metal layers to be deposited separately can be dimensioned so that the intensity of the transmitted light can be adjusted exactly depending on the selected application site of the logo.

According to another preferred embodiment of the invention, the electrolytic coating with copper has a thickness of at most 4 μm, and the electrolytic coating of the copper surface with chromium has a thickness of at most 2 μm. These very thin coatings can be maintained with electrolytic deposition of the metals, so that the desired brightness effect is not diminished.

### BRIEF DESCRIPTION OF THE DRAWING

Additional details of the invention can be ascertained from the following detailed description and the appended drawings where a preferred embodiment of the invention is illustrated as an example.

The drawings show in:

FIG. 1 a partially cut-open side view of a window opener,

FIG. 2 a partially cut-open top view of a window opener according to FIG. 1,

FIG. 3 a cross section through the window opener taken along the line III-III in FIG. 2,

FIG. 4 a top view of a partially cut-open direction arrow,

FIG. 5 a top view on a logo of a motor vehicle,

FIG. 6 a cross-sectional through a portion of the logo taken along the line VI-VI in FIG. 5,

FIG. 7 a top view on another logo,

FIG. 8 a cross section through the logo of FIG. 7 taken along the line VIII-VIII in FIG. 7,

FIG. 9 a backside view of a logo,

FIG. 10 a view of a tailgate of a motor vehicle, and

FIG. 11 a diagram of an apparatus for coating metals with an electrolytic process.

### DETAILED DESCRIPTION OF PREFERRED EMBODIMENTS

The window opener 50 consists essentially of a handle portion 51 and a mounting portion 52. The mounting portion 52 has a square 53 which is used for coupling the window opener 50 to a closing mechanism (not illustrated) of a window 54. Pivoting the handle portion 51 pivots the square 53 about a longitudinal axis 55 of the mounting portion 52, whereby the un-illustrated closing mechanism of the window 54 is either opened or closed, depending on the rotation direction. The handle portion 51 is has a plastic core 56 through which a hollow space 57 extends. An illuminator 58, which lights up when an electric voltage is applied, is installed in this hollow space 57. The illumination intensity of the illuminator 58 is selected so that the light is transmitted through the walls 59, 60 of the plastic core 56. The plastic core 56 is therefore made of a transparent plastic material.

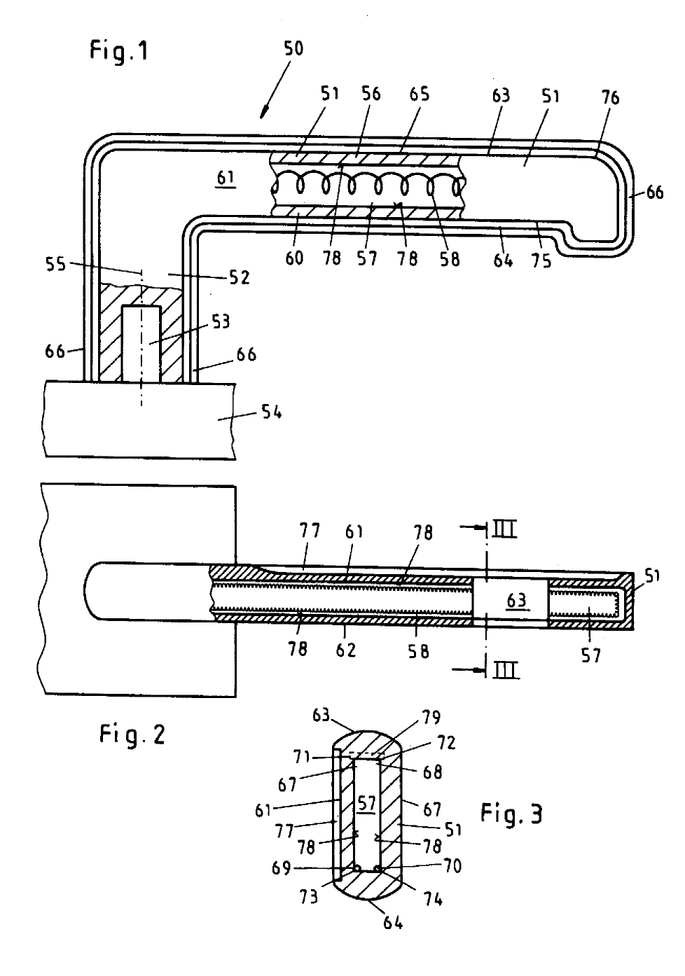

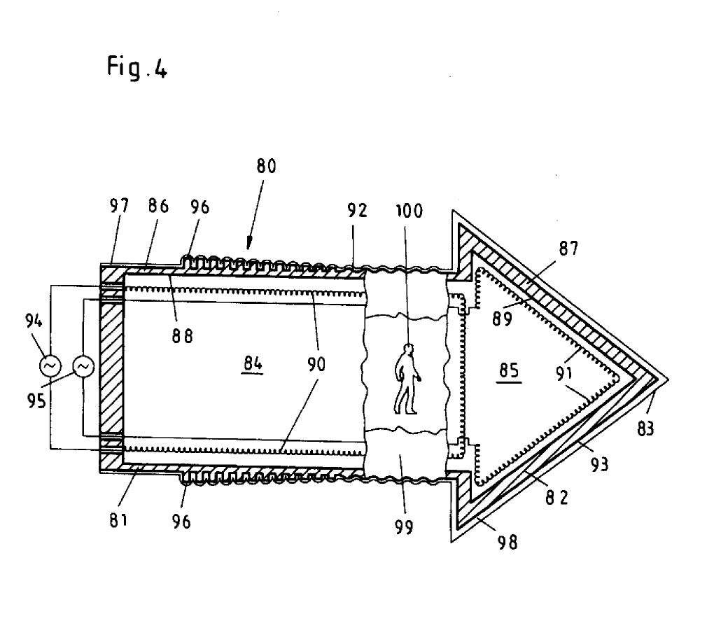

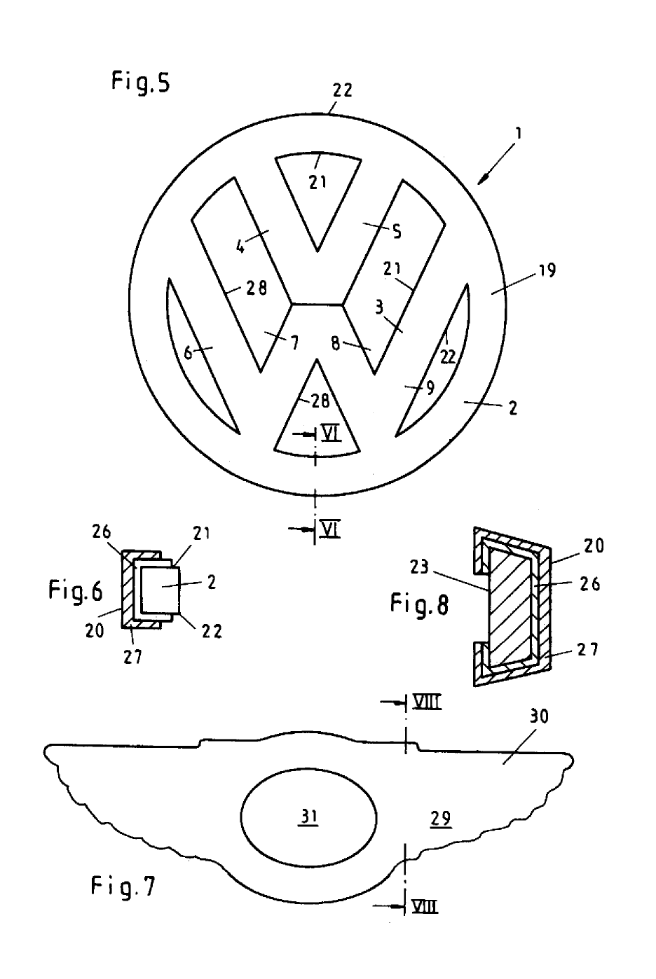

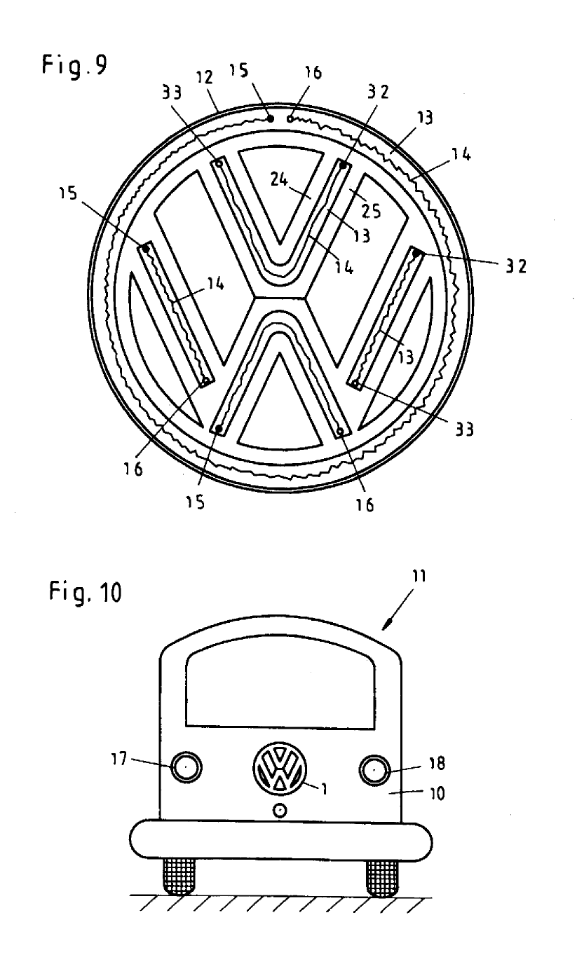

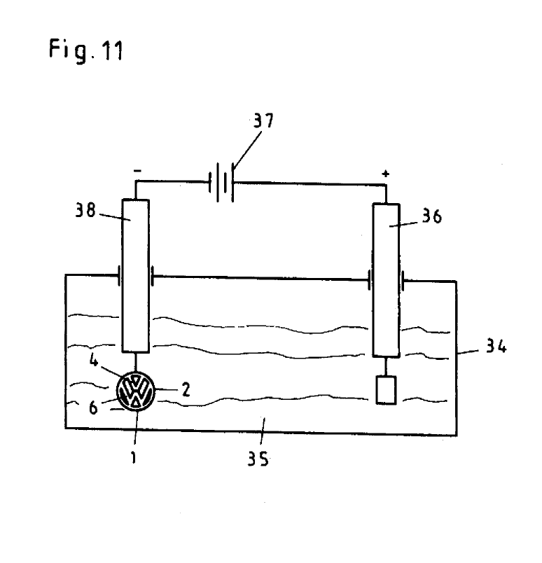

In the arrangement of the illuminator 58 depicted in FIG. 1, sidewalls 61, 62 and optionally also the top and bottom cover surfaces 63, 64 light up. Depending on the illumination intensity of the illuminator 68 and on the transparency of the plastic core 56, the contour of the handle portion 51 is outlined, so that it can be grasped and operated in the dark.

The handle portion 51 may be surrounded by a foil 65 which can be colored or covered with a colored layer 66. This colored layer may develop different color nuances depending on the color of the light emitted by the illuminator 58. For example, the color layer can light up red when illuminated by red light from the illuminator 58, whereas the foil 65 lights up green when illuminated by green light from the illuminator 58. The window opener 50 may include switching means for switching the illuminator from red light to green light. The switching means are activated by rotating (not illustrated) the handle portion 51, so that the handle portion 51 is illuminated red when the window is open and green when the window is closed. Alternatively, two different illuminators 58 may be arranged in the hollow space 57, with one of them emitting red light and the other green light.

In many applications for marking objects, it is sufficient to illuminate individual edges. FIGS. 2 and 3 show illuminators 67, 68, 69, 70 extending along delimiting edges 71, 72, 73, 74. The illumination intensity of these illuminators 67, 68, 69, 70 along the delimiting edges 71, 72, 73, 74 is limited to the lines formed by the delimiting edges. Because every person knows the structure of window openings 50, s/he will recognize the lines 75, 76 regardless if s/he recognizes the walls 61, 62 located between the lines 75, 76. The wall 61 located on the side of the handle portion 51 can also have a two-dimensional indentation 77 extending over the entire area, with that area lighting up when the illuminator 58 is switched on. The contour of the handle portion 51 can then be readily recognized even in the dark. In indentation 77 can also be formed at least on both sides of the handle portion 51, possibly also in the region of the top cover surface 63 and the bottom cover surface 64. Instead of providing illumination with illuminators 67, 68, 69, 70 in string form, the bottom surfaces 78 of the transparent walls 59, 60; 61, 62 facing the illuminators 67, 68, 69, 70 can also be covered with two-dimensional illuminators 79 which uniformly illuminate the entire bottom surface 78. However, a substantial amount of electrical energy must be supplied to the two-dimensional illuminator 79, necessitating considerable insulation.

The invention can also be applied to a high-end direction sign 80, for example for indicating emergency exits. This direction sign 80 includes a shaft portion 81 and an information portion 82 with a tip 83 pointing towards the exit. Both the shaft portion 81 and the information portion 82 have corresponding hollow spaces 84, 85, in which illuminators 90, 91 extend along the corresponding wails 86, 87 of the bottom surfaces 88, 89. These illuminators illuminate the bottom surfaces 88, 89 so that light is discernible at their surfaces 92, 93, in particular in the dark, with a suitable transparent design of the walls 86, 87. The illuminator 90 extending through the shaft portion 81 is powered by a first current source 94, while the illuminator 91 extending through the information portion 82 is powered by a second current source 95. Depending on the importance, the illuminators 90, 91 may be constructed differently. For example, the illuminator 90 in the shaft portion 81 may emit light with a constant intensity towards the bottom surface 88, whereas the illuminator 91 disposed in the information portion 82 may illuminate the walls 87 of the tip 83 with intermittent high-intensity light, so that a viewer can readily identity the direction s/he need to take. Alternatively or in addition, the illuminators 90, 91 may be provided with light pulses propagating towards the tip 83, so that the entire direction sign 80 points to the direction to be taken.

Finally, the illuminators 90, 91 may also have different colors. For example, the illuminator 90 in the shaft 81 may attract attention by providing white illumination, whereas a red light emitted by the illuminator 91 may point in the information portion 82 to the importance of the direction to be taken.

The surfaces 92, 93 of the shaft portion 81 as well as of the information portion 82 may be constructed differently. For example, the shaft portion 81 may have a surface 92 with raised portions 96. The individual raised portions 96 reflect with particular intensity light incident from the outside and therefore attract attention. Conversely, the surface 92 of the information portion 82 may be smooth, so that the direction indicated by the direction sign 80 can be unambiguously identified.

The direction indicated by the direction sign 80 can also be emphasized by decreasing the size and the number of the raised portions 96 towards the information portion 82. This draws the attention of a viewer passing by to the information portion 82.

The surfaces 92, 93 of the shaft portion 81 and of the information portion 82 are colored, for example by applying a signal color or a strongly reflecting coating, for example metal with a silvery gloss. A color coating 97, 98, which can be adapted to the significance of the respective shaft portion 81 and/or information portion 82, is hereby formed on the respective surfaces 92, 93, wherein for example the color coating 97 of the shaft portion 81 can be implemented with a silvery gloss to attracting a viewer's attention, whereas the color coating 98 of the information portion 82 is provided in a red color to clearly mark the direction to be taken.

To this end, areas 99 with different light transparency 99 can be produced by constructing the walls 86 and/or the color coating 97 differently. Symbols can be applied to the surfaces 92, 93 in these areas 99, which unambiguously identify the meaning of the direction sign, for example a symbol of a running person 100 who runs away from the danger zone in the direction indicated on the direction sign 80.

A logo represents another example of an object, where a bottom surface facing away from the viewer is illuminated by an illumination source and a surface facing the viewer reflects incident light. For example, a logo 1 used by a known automobile manufacturer consists essentially of lines 2, 3, with a surrounding circular line 2 surrounding an arrangement of straight lines 3 which terminate in the circular line 2. This straight lines 3 delimit two letters positioned on top of one another, of which the upper letter is formed as “V” and the lower letter as “W”. While the upper letter has two upwardly pointing lines 4, 5, the lower letter has four upwardly pointing lines 6, 7, 8, 9. Both the circular line 2 and the upwardly pointing lines 4, 5; 6, 7, 8, 9 are made from a transparent plastic material. The logo 1 is intended for attachment to an object 10, for example the tailgate of an automobile 11.

The transparent material of the lines 2, 3 of the logo 1 can be made of a plastic material and provided on a rear surface 12 of the logo 1 facing an object 10 with groove-shaped recesses 13. These recesses 13 extend through the individual lines 2, 3, 4, 5, 6, 7, 8, 9. Illuminators 14 which are connected with an unillustrated current source by conductors are arranged in the individual recesses 13. The illuminators 14 can be switched on, for example, at the same time that other illuminators, for example the taillights 17, 18, are switched on.

The front surfaces 19 of the lines 2, 3 of the logo 1 facing away from the rear surface 12 include a reflective metallic coating. This coating can be directly applied on the lines 2, 3, 4, 5, 6, 7, 8, 9. Importantly, this coating is transparent for light produced by the illuminators 14. The light is transmitted both through the plastic material from which the logo 1 is made, and through the reflective metallic coating. In this way, the logo 1 has a reflective metallic surface when viewed under incident light, for example in daylight. Conversely, in the dark, when the illuminator 14 is switched on, the path of the lines 2, 3, 4, 5, 6, 7, 8, 9 is outlined, so that these lines 2, 3, 4, 5, 6, 7, 8, 9 can also be recognized in the dark.

Instead of a corresponding coating of the lines 2, 3, 4, 5, 6, 7, 8, 9, a suitably colored plastic foil 20 can also be applied to the plastic material of the logo 1. This plastic foil 20 can be fixedly connected with the plastic material of the lines 2, 3, 4, 5, 6, 7, 8, 9, for example with an adhesive. The plastic foil 20 is firmly stretched over the corresponding lines 2, 3, 4, 5, 6, 7, 8, 9, thereby producing a uniformly reflecting surface of these lines 2, 3, 4, 5, 6, 7, 8, 9. The plastic foil 20 is attached either at the lateral boundaries 21, 22 of the lines 2, 3, 4, 5, 6, 7, 8, 9 or at their rear boundary 23. Those two-dimensional sections 24, 25 of the rear boundary 23, which extend through the lines 2, 3, 4, 5, 6, 7, 8, 9 on both sides of the recesses 13, are adequate for attaching the plastic foil 20.

The plastic foil 20 has a supporting foil 26 to which a coating 27 is applied. This coating can be made of chromium or another metal that provides a silver-colored reflection and is, for example, sprayed onto the supporting foil 26. The coating 27 adheres to the supporting foil 26 so firmly that the plastic foil 20 can be bent even at the sharp corners of the individual lines 2, 3, 4, 5, 6, 7, 8, 9 without causing detachment of the coating 27 from the supporting foil 26.

Instead of a silvery glossy deposit on the individual lines 2, 3, 4, 5, 6, 7, 8, 9, other desired effects can be produced by selecting corresponding colors, for example with a logo of FIG. 3 a gold-colored coloration of the surface 29. It is also feasible to coat only portions of this two-dimensional logo 30 and leave other areas 31 uncoated, so that other special partial features can be attached thereon.

Any type of lamp that emits light in response to an electric current can be used as an illuminator 14. To this end, an input voltage is applied to electrically light-emitting sub-elements at contacts 32, 33. However, care should be taken to prevent the illuminators 14 from producing excessive heat when switched on, which would be detrimental for the plastic material of the logo 1 and for the object 10 on which the logo 1 is to be attached. For example, the varnish applied to the motor vehicle 11 should also be taken into consideration.

The logo 1 is produced by casting a suitable plastic material in a corresponding mold. The mold can be configured so that the recesses 13, into which the illuminators are to be inserted, are taken into account during the molding process. However, the recesses 13 can also be applied by a machining operation after completion of the logo 1.

The prefabricated illuminators 14 of suitable shape are then inserted into the recesses 13, and the contacts 32, 33 are aligned so that matching contact pins (not illustrated) project into the contacts 32, 33. LED lights can also be used as Illuminators.

The logo can be placed with its rear surface 12 directly on the object 10. However, the rear surface 12 can also be first covered with a heat-insulating cover foil (not illustrated) which is then located between the rear surface 12 and the object 10.

The logo 1 produced in this manner appears with a metallic gloss under incident light, for example daylight. To this end, the coating 27 applied to the supporting foil 26 contacts an outside surface of the supporting foil 26 that faces away from the logo 1. Because both the supporting foil 26 and the coating 27 are transparent for light, the entire logo lights up after the illuminator 14 is switched on.

The logo 1 can also be produced from other transparent materials, not only from plastic. All known coloration processes can be employed for applying color, for example brush-painting, spray-coating, evaporation. The colored layer may be applied directly on the material of the logo 1. Coating processes may also be used where several layers are applied sequentially. Not only paints or dyes, but also evaporated metals, for example aluminum, chromium or other metals suitable for evaporation, can be used for coloring the surface.

A very precisely metal coating can also be applied on the transparent material with an electrolytic process. To this end, a container 34 is filled with an electrolyte 35, wherein current from a DC source 37 is introduced through an anode 36 and conducted to a cathode 38. The electrolyte 35 is hereby dissociated and its metal ions migrate to the cathode 38. The logo 1 to be coated with metal is attached on the cathode 38, and the metal dissociated from the electrolyte 35 is deposited on the lines 2, 3, 4, 5, 6, 7, 8, 9. The quantity of the metal deposited on the lines 2, 3, 4, 5, 6, 7, 8, 9 depends on a number of factors, such as the current density and the time during which the current is applied to the electrolyte 35. By taking these factors into account, the thickness of the metal layer deposited on the logo 1 can be exactly specified. For example, a base layer made of copper having a thickness of at most 4 μm can be deposited on the transparent plastic material. The logo 1 coated in this manner can then be suspended in another electrolyte (not illustrated) which dissociates chromium when an electric current is applied. The chromium can be deposited on the already existing copper layer, thereby producing a very durable and high-gloss chromium layer. The thickness of this chromium layer also depends on the various factors affecting the electrolyte, wherein the thickness of the chromium layer to be applied on the existing copper deposit can be exactly specified, depending for example on the current density and the time during which the current is applied. The coatings applied on the logo 1 by electrolysis are advantageously very dense and produce a high-gloss surface. In addition, the electrolytically applied medals are firmly connected with the transparent material.

What is claimed is:

1. An article made of a transparent material, comprising:
a bottom side illuminated by light from at least one illumination source, and
a top side located opposite the bottom side and being partially transparent to the light from the at least one illumination source exiting from the top side,
wherein the top side is made at least partially from a reflecting material which reflects external light incident on the top surface,
wherein the article comprises a contour having edge boundaries delineating a region of at least characteristic design portions of the article and wherein the contour is illuminated by the at least one illumination source which extends along individual edges formed by the edge boundaries and produces a brightness which is limited to the characteristic design portions.

2. The article of claim 1, wherein the article has different wall thicknesses, with the different wall thicknesses producing, depending on a respective wall thickness, a different reflection of the incident light and a different transmission of the light from the at least one illumination source that illuminates the bottom side.

3. The article of claim 1, wherein the top side has regions of different coloration affecting the reflection of the external light.

4. The article of claim 3, wherein the regions of different coloration comprise a combination of differently colored partial layers.

5. The article of claim 4, wherein each of the differently colored partial layers is made of a supporting foil having a colored coating, with light transmitted through the differently colored partial layers has a mixed color resulting from the colored coatings.

6. A logo attached to an article for identifying the article, comprising:
a three-dimensional structure in the form of a characteristic arrangement of lines made of a transparent material,
at least one illumination unit associated with each line and tracing a shape of each line,
wherein light from the at least one illumination unit is introduced into the transparent material on a bottom side of the article and passes through the transparent material towards a top side of the article located opposite the bottom side, wherein the top side comprises a coloration, which allows the light from the at least one illumination unit to pass through and which partially reflects externally incident light.

7. The logo of claim 6, wherein the coloration is embodied as a colored partially transparent plastic foil having a corresponding coloration.

8. The logo of claim 7, wherein the coloration of the partially transparent plastic foil is embodied as a coating disposed on a surface of the partially transparent plastic foil, with the coating facing away from an exposed front surface of the logo.

9. The logo of claim 7, wherein externally incident light is partially reflected by the plastic foil with a silvery color.

10. The logo of claim 6, wherein the silvery color is produced by an evaporated aluminum layer.

11. The logo of claim 6, wherein the coloration is embodied as several superpositioned layers applied on the lines.

12. The logo of claim 6, wherein the transparent material comprises a plastic material.

13. The logo of claim 11, wherein at least one of the superpositioned layers is electrolytically deposited on the transparent material.

14. The logo of claim 13, wherein the at least one electrolytically deposited layer has a thickness allowing transmission of light through the transparent material and through the electrolytically deposited layer.

15. The logo of claim 6, wherein the transparent material comprises a cover layer facing away from the article with a thickness of at most 10 μm.
